(19) United States
(12) Patent Application Publication
(10) Pub. No.: US 2010/0141558 A1
(43) Pub. Date: Jun. 10, 2010

(54) PLASMA DISPLAY DEVICE

(75) Inventor: Jae-Young Yeo, Gyeonggi-do (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD, Gyeonggi-do (KR)

(21) Appl. No.: 12/478,641

(22) Filed: Jun. 4, 2009

Related U.S. Application Data
(60) Provisional application No. 61/060,367, filed on Jun. 10, 2008.

(51) Int. Cl. G09G 3/20

(52) U.S. Cl. 345/58

(57) ABSTRACT

A plasma display device having reduced electro-magnetic interference (EMI) is disclosed. The display device has a filter in front of a plasma display panel. The plasma display panel (PDP) generates EMI noise during operation, and the filter is driven with a noise cancellation signal to at least partially cancel the EMI noise generated by the PDP.

### CROSS REFERENCE TO RELATED APPLICATIONS

This application claims priority to U.S. Provisional Application No. 61/060,367, titled “Plasma Display Device,” filed Jun. 10, 2008, the specification of which is hereby incorporated by reference, in its entirety.

### BACKGROUND

1. Field

The field relates to a plasma display device. More particularly, it relates to a plasma display device that has reduced radiation noise of a plasma display panel (PDP).

2. Description of the Related Technology

In general, a plasma display device includes a plasma display panel (PDP) module that generates images by using plasma, and a support structure that supports the PDP module.

For example, the PDP module may include a chassis base that supports the PDP and a plurality of printed circuit boards (PCBs) that are mounted on the chassis base and connected to the PDP.

As an example, the support structure may include a back cover, a filter, and a filter bracket. The back cover may have a thickness of about 1 mm, be made of a metal material, and cover a rear side of the PDP module. The filter shields the front side of the PDP module, and the filter bracket connects the back cover and the filter at a side of the PDP module.

A conventional support structure is connected to the PDP module through one or a plurality of connection members, supports the PDP module, and grounds the PDP module.

The PDP generates images by using sustain discharges after address discharges, where a pulse of about 250 KHz is used for the sustain voltages when the sustain discharge occurs.

When the sustain discharge occurs, radiation noise is emitted from the PDP and the PDP module, and the amount of radiation noise due to the sustain voltage pulse is given as Equation 1 and Equation 2.

α_{E}[dB]=322+10 log [(τᵣ)/(f³ μᵣ r²)] Equation 1

α_{H}[dB]=14.6+10 log [(σᵣ f r²)/(μᵣ)] Equation 2

Here, α_{E} denotes electric field reflectance, α_{H} denotes magnetic field reflectance, σᵣ denotes conductivity, f denotes frequency, μᵣ denotes relative permeability, and r denotes a distance between a noise source and a shielding material.

One significant noise source is a magnetic source, which generally generates noise in a low frequency band. The radiation noise from the magnetic source can be determined using Equation 2.

The magnetic field source having a frequency band of several MHz cannot be effectively shielded by a shielding metal (e.g., back cover or filter) having a thickness of about 1 mm.

### SUMMARY OF CERTAIN INVENTIVE ASPECTS

Embodiments relate to a plasma display device having an advantage of reducing radiation noise of a PDP.

One aspect is a plasma display device. The device includes a plasma display panel (PDP), which generates radiated noise when driven with one or more driving signals. The device also includes a radiation screen in front of the PDP, and a noise elimination circuit configured to drive the radiation screen with a noise cancellation signal, where the radiation screen generates noise cancellation radiation configured to at least partly cancel the radiated noise from the PDP.

Another aspect is a method of reducing radiated noise from a plasma display device. The method includes applying driving signals to a plasma display panel (PDP), where the PDP radiates noise, generating a noise cancellation signal, and applying the noise cancellation signal to the front of the PDP, where noise cancellation radiation generated in response to the noise cancellation signal at least partly cancels the radiated noise from the PDP.

Another aspect is a plasma display device. The device includes means for applying driving signals to a plasma display panel (PDP), where the PDP radiates noise, means for generating a noise cancellation signal, means for applying the noise cancellation signal to the front of the PDP, and means for generating noise cancellation radiation in response to the noise cancellation signal, where the radiated noise from the PDP is at least partly canceled.

### Certain Advantageous Effects

As described, according to certain exemplary embodiments, a radiation noise elimination circuit applies an inverse pulse of radiation noise radiated from the PDP and the PDP module so that radiation noise can be reduced. Accordingly, electromagnetic interference between the PDP module and peripheral electronic devices can be minimized.

### BRIEF DESCRIPTION OF THE DRAWINGS

FIG. 1 is an exploded perspective view of a plasma display device (PDP) according to an exemplary embodiment.

FIG. 2 is a cross-sectional view of the PDP of FIG. 1, taken along the line

FIG. 3 is a perspective view of a filter bracket and an insulation cushioning member of FIG. 1.

FIG. 4 is a front view of the filter bracket.

FIG. 5 is a waveform diagram of a sustain voltage pulse, a radiation noise pulse, and a inverse pulse.

FIG. 6 is a block diagram showing components for eliminating radiation noise.

FIG. 7 is a radiation noise elimination circuit diagram.

FIG. 8 is a graph showing spectral characteristics of radiation noise of a conventional display.

FIG. 9 is a graph showing spectral characteristics of radiation noise after the effects of applying noise reduction.

### DETAILED DESCRIPTION OF CERTAIN INVENTIVE EMBODIMENTS

Certain embodiments will be described with reference to the accompanying drawings, in which exemplary embodiments of the invention are shown. As those skilled in the art would realize, the described embodiments may be modified in various ways, without departing from the spirit or scope of the present invention. The drawings and description are to be regarded as illustrative in nature and not restrictive. Like reference numerals generally designate like elements throughout the specification.

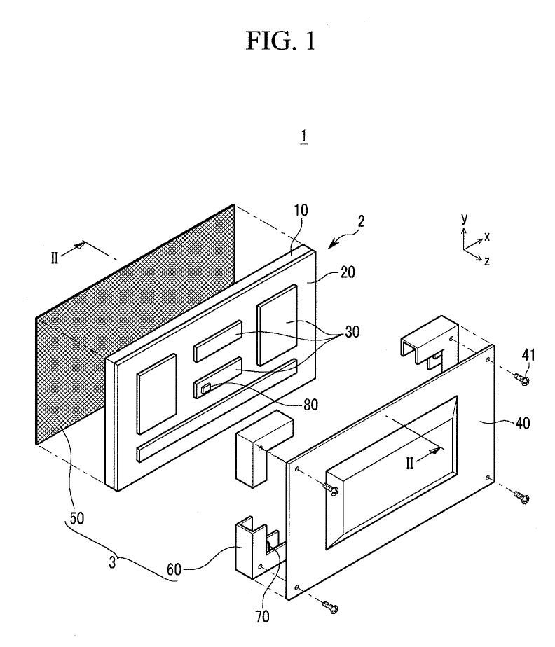

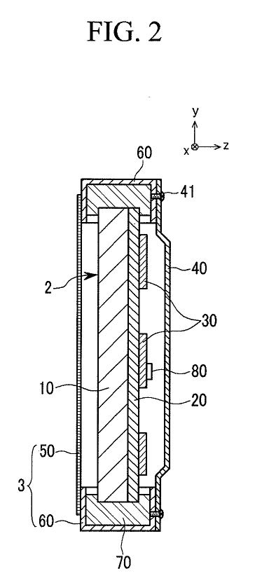

FIG. 1 is an exploded perspective view of a plasma display device according to an exemplary embodiment, and FIG. 2 is a cross-sectional view of FIG. 1, taken along the line II-II.

Referring to FIG. 1 and FIG. 2, a plasma display device 1 includes a plasma display panel (PDP) module 2 that generates an image by using plasma that is generated by a gas discharge, and a support structure 3, electrically floated from the PDP module 2, that supports the PDP module 2.

For example, the PDP module 2 includes a PDP 10 that displays an image, and a chassis base 20 that supports the PDP 10. In addition a plurality of printed circuit boards (PCBs) 30 that drive the PDP 10 may be placed on the PDP module 2.

The chassis base 20 is attached to a rear side of the PDP 10 and supports the PDP 10. In this embodiment, the PCBs 30 are mounted on the chassis base 20 attached to the rear side of the PDP 10, and are electrically connected (connections not shown) to the PDP 10 for driving the PDP 10.

One advantageous aspect of certain embodiments relates to the combination of the PDP module 2 and the support structure 3.

The support structure 3 is connected to the PDP module 2, and covers and shields the PDP module 2. Accordingly, the support structure 3 supports and protects the PDP module 2. When driving the PDP 10, the support structure 3 supports the PDP module 2 and remains electrically floated from the PDP module 2 so as to decrease radiation noise from the PDP module 2.

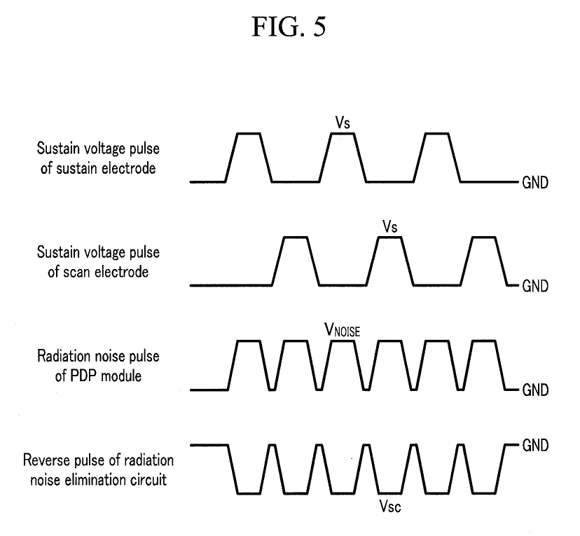

Since the PDP module 2 is electrically floated from the support structure 3, the radiation noise that is radiated from the PDP module 2 is not conducted to the support structure 3. The radiation noise from the PDP module 2 can have a waveform corresponding to a sum of sustain voltage pulses applied to the sustain electrode and sustain voltage pulses applied to the scan electrode (see FIG. 5).

The radiation noise may have, for example, a frequency range of about 30 MHz to about 1 GHz. A fundamental frequency of the sustain voltage pulse is about 250 KHz, but harmonic components of the sustain voltage pulse exist within the range of about 30M to about 100 Mhz.

As an example, the support structure 3 may include a back cover 40 that covers a rear part of the PDP module 2, a radiation screen/filter 50 in front of at least part of the PDP module 2, and a filter bracket 60 that covers a side part of the PDP module 2. In some embodiments, the back cover 40 is made of a metal plate or a synthetic resin material.

The radiation screen/filter 50 is attached to a front part of the filter bracket 60, and may optically and/or electromagnetically act on the PDP 10 or the image generated by the PDP 10. The radiation screen/filter 50 may comprise a filter 50 to reduce reflection of light incident on the PDP 10. Reduced reflection, may, for example increase contrast in bright ambient conditions. Additionally or alternatively, the filter 50 may shield radiation or EMI emitted from the PDP 10. In some embodiments, the filter 50 substantially covers the entire front surface of the PDP 10. In some embodiments, the filter 50 is formed of a metal-mesh filter or a sputter filter. The filter 50 may include a conductive layer that is formed by a metal mesh or a transparent conductor such as ITO (indium tin oxide) or ZnO (zinc oxide). In some embodiments, a metal mesh pattern is aligned with non-discharge regions of the PDP to avoid blocking the light emitted from PDP.

The filter bracket 60 enables the PDP module 2 to be installed inside the support structure 3 by connecting the back cover 40 and the filter 50.

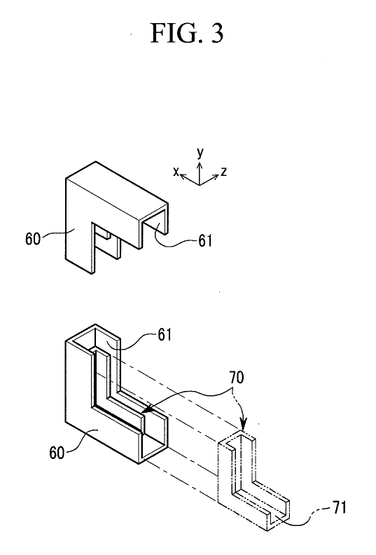

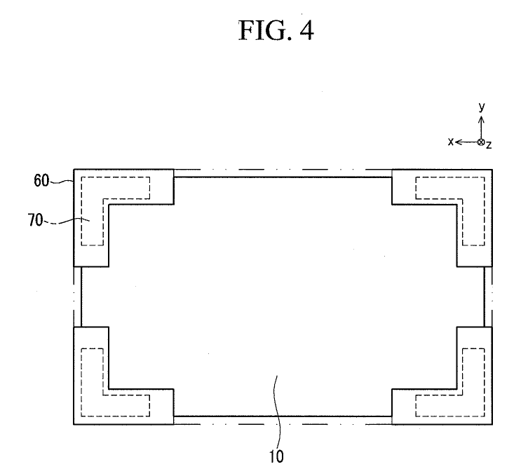

FIG. 3 shows a perspective view of the filter bracket 60 and an insulation cushioning member 70 of FIG. 1, and FIG. 4 is a front view of four filter brackets.

Referring to FIG. 3 and FIG. 4, the filter brackets 60 in this embodiment, are disposed at four corners of the PDP module 2. If, for example, the size of the PDP module 2 is large, more filter brackets 60 can be used. For example, filter brackets of a modified shape may be placed between the corners of the PDP module for supporting each edge of the PDP module 2.

The filter bracket 60 is connected to the back cover 40 and is attached to and supports the PDP module 2. In addition, the filter brackets 60 may comprise at least two filter brackets that are connected to two facing edges of the PDP module. In this case, placement of a flexible printed circuit (FPC) (not shown) that connects the PDP and the PCBs may be uninterrupted.

The plasma display device 1 includes an insulation cushioning member 70. The insulation cushioning member 70 is placed between the filter bracket 60 and the PDP module 2, and enables the electrical isolation of the PDP module 2 and the support structure 3. That is, the insulation cushioning member 70 electrically insulates the filter bracket 60 and the PDP module 2. In addition, the insulation cushioning member 70 reduces external shock transmitted to the PDP module 2 by absorbing external vibration transmitted to the support structure 3. In some embodiments, the insulation cushioning member 70 is made of rubber, flexible synthetic resin, or silicone resin.

The shape of the insulation cushioning member 70 may vary according to the shapes of the filter bracket 60 and the PDP module 2, and supports the PDP module 2.

For example, if a filter bracket 60 is provided in each of the four corners of the PDP module 2, the insulation cushioning member 70 can likewise be provided in each of the four corners of the PDP module 2 corresponding to each of the filter brackets 60.

The filter bracket 60 has a groove 61 corresponding to the insulation cushioning member 70. The insulation cushioning member 70 has a groove 71 corresponding to the corner of the PDP module 2, and the insulation cushioning member 70 is inserted into the groove 61. The PDP module 2 is inserted into the groove 71 of the insulation cushioning member 70. Accordingly, the PDP module 2 is supported by the insulation cushioning member 70.

Referring again to FIG. 1 and FIG. 2, the plasma display device 1 is assembled by inserting the insulation cushioning member 70 to the filter bracket 60, mounting the PDP module 2 to the insulation cushioning member 70, and mounting the filter 50 and the back cover 40 on the front and rear sides of the filter bracket 60, respectively. The back cover 40 and the filter bracket 60 can be combined by a screw 41.

The plasma display device 1 has the insulation cushioning member 70 for electrically isolating the PDP module 2 from the support structure 3, and further includes a radiation noise elimination circuit 80 for reducing radiation noise. Other mechanisms may be used to mount the filter 50 to the PDP module 2.

The plasma display device 1 may include the radiation noise elimination circuit 80. In some embodiments, the radiation noise elimination circuit 80 is included in the PCBs 30, shown in FIG. 1.

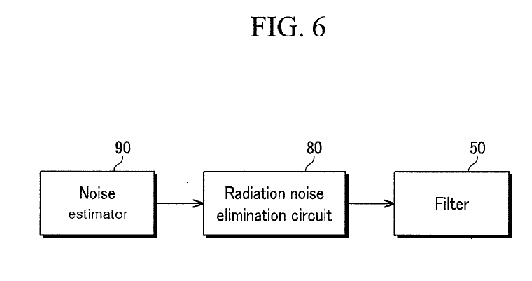

FIG. 5 is a waveform diagram showing sustain voltage pulses of a sustain electrode and of a scan electrode, a radiation noise pulse, and a inverse pulse of the radiation noise elimination circuit 80. FIG. 6 is a block diagram illustrating the process of radiation noise elimination.

Referring to FIG. 5, when the PDP 10 is driven with the sustain voltage pulses, radiation noise is generated from the PDP 10 and the PDP module 2 due to sustain voltage pulses.

Referring to FIG. 6, a noise estimator 90 estimates the noise generated by the PDP. For example, the noise estimator 90 may use the sum of the sustain voltage pulse of a sustain electrode and the sustain voltage pulse of a scan electrode in order to estimate the noise Vnoise of the PDP module 2 and to generate a noise radiation estimate signal Vest.

For example, when the PDP 10 is driven, sustain voltage pulses respectively applied to the scan electrode (not shown) and the sustain electrode (not shown) have a sustain voltage Vs which are alternately applied to the sustain electrode and the scan electrode.

Accordingly, radiation noise Vnoise from the PDP module 2 due to the sustain discharge has a waveform that corresponds to the sum of the sustain voltage pulses of the sustain electrode and the scan electrode.

The noise estimator 90 receives the sustain voltage pulse of the sustain electrode and the sustain voltage pulse of the scan electrode, generates a noise estimate Vest by adding the two voltage pulses, and transmits the generated noise estimate Vest to the radiation noise elimination circuit 80.

Alternatively, the noise estimator 90 may be replaced with a noise detector. The noise detector can directly or indirectly detect the radiation noise Vnoise radiated from the PDP module 2, and transmit a detected noise signal Vdet representing the detected radiation noise Vnoise to the radiation noise elimination circuit 80.

The radiation noise elimination circuit 80 generates a noise cancellation signal based on one or both of the noise estimate Vest and the detected noise signal Vdet and applies the noise cancellation signal to the filter 50 so as to at least partially cancel the radiation from the plasma display device 1. In some embodiments, the noise cancellation signal has polarity opposite that of either or both of the noise estimate Vest and the detected noise signal Vdet.

Accordingly, the radiation noise elimination circuit 80 receives either or both of the generated noise estimate Vest and the detected noise signal Vdet that corresponds to the radiation noise pulse Vnoise of the PDP module 2, and outputs the noise cancellation signal to the filter 50.

As shown in FIG. 5, the noise cancellation signal has a pulse voltage Vsc that is lower than a reference voltage. Here, the reference voltage is the ground voltage (GND). As described above, in the plasma display device 1, the radiation noise Vnoise is generated from the PDP 10 and the PDP module 2 when the PDP 10 is driven, and the radiation noise elimination circuit 80 generates the noise cancellation signal.

Accordingly, radiation noise Vnoise of the PDP module 2 and noise cancellation radiation from the filter 50 generated in response to the noise cancellation signal of the radiation noise elimination circuit 80 are both produced. Because the noise cancellation radiation is configured to at least partly cancel the Vnoise of the PDP module 2, the total radiation is less than that generated by the radiation noise pulse Vnoise of the PDP module 2 alone.

In some embodiments, the radiation screen 50 does not have a significant filtering effect for the display. Accordingly, the radiation screen may be in front of the PDP and may substantially cover the display area of the PDP or at least a portion of the display area of the PDP. The radiation screen receives the noise cancellation signal and generates noise cancellation radiation which at least partly cancels the radiation noise of the PDP.

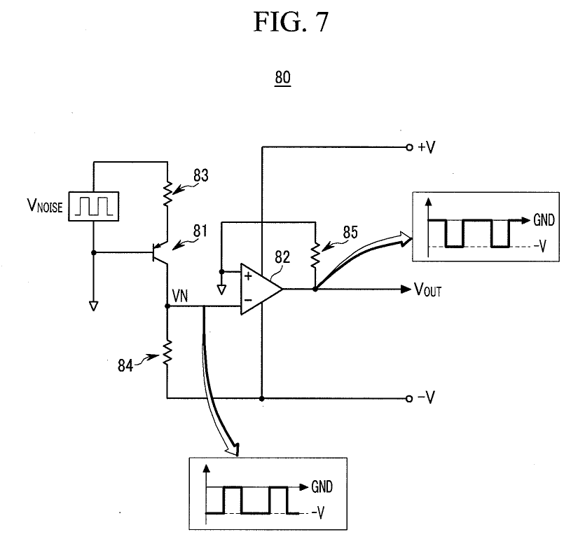

FIG. 7 is a radiation noise elimination circuit diagram. Referring to FIG. 7, the radiation noise elimination circuit 80 includes a bipolar junction transistor (BJT) 81, a comparator 82, and first, second, and third resistors 83, 84, and 85. In this embodiment, the BJT 81 is a PNP-type BJT, and the base thereof is grounded, the noise cancellation signal is input to the emitter, and the collector is connected to the resistor 84 and the inverting terminal (−) of the comparator 82. The non-inverting terminal (+) of the comparator 82 is grounded. The first resistor 83 is connected between the base and the emitter of the BJT 81. When the noise cancellation signal is input, the emitter voltage is based in part on the value of the first resistor 83. A first end of the second resistor 84 is connected to the inverting terminal (−) and a second end is applied with a negative voltage −V. The third resistor 85 is connected between the grounded non-inverting terminal (+) and the output of the comparator 82. When a voltage difference between the base and the emitter is greater than a threshold voltage, the BJT 81 is turned on. In the case of a PNP-type BJT 81, an emitter voltage should be greater than a base voltage and a voltage difference therebetween should be greater than the threshold voltage in order to turn on the BJT 81. When the BJT 81 is turned on, a voltage signal VN that corresponds to the noise cancellation signal is input to the inverting terminal (−) of the comparator 82. The comparator 82 compares the voltage signal VN input to the inverting terminal (−) with the ground voltage of the non-inverting terminal (+), and generates an output signal Vout according to the comparison result. The comparator 82 generates an output signal of the ground voltage GND when the signal input to the non-inverting terminal (+) is greater than the signal input to the inverting terminal (−), and generates an output signal of the negative voltage −V when the signal input to the non-inverting terminal (+) is less than the signal input to the inverting terminal (−). The output signal of the comparator 82 according to the exemplary embodiment swings between the negative voltage −V and the ground voltage GND in accordance with the comparison result.

When the noise cancellation signal is low, the emitter voltage of the BJT 81 is reduced so that the BJT 81 is off. Then, current does not flow to the second resistor 84 so that the voltage signal VN becomes the negative voltage −V. The comparator 82 generates an output signal Vout of the negative voltage −V. Accordingly, in this embodiment, the noise elimination circuit comprises a level shift circuit to level shift the radiation noise signal and a buffer circuit configured to generate the radiated noise cancellation signal.

When the noise cancellation signal is high, the BJT 81 is turned on, and a voltage difference between the voltage of the noise cancellation signal and the negative voltage −V is distributed according to a resistance ratio between the first resistor 83 and the second resistor 84. The resistance ratio between the first and second resistors 83 and 94 according to one exemplary embodiment of the present invention is set for the voltage signal VN to be greater than the ground voltage GND when the noise cancellation signal is input. Accordingly, when the noise cancellation signal is input, the comparator 82 generates an output signal Vout of the ground voltage GND since the voltage signal VN is greater than the ground voltage GND. FIG. 7 shows the noise cancellation signal and the voltage signal VN, but the waveforms of the noise cancellation signal and the voltage signal VN are not limited thereto. When the BJT 81 is not turned on, even though the noise cancellation signal is input, the voltage signal VN does not become greater than the ground voltage GND, and therefore the radiation noise elimination circuit 80 can have a minimum threshold for the noise cancellation signal.

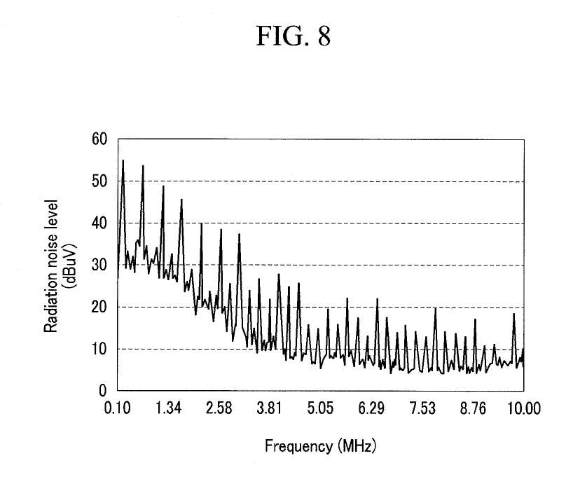

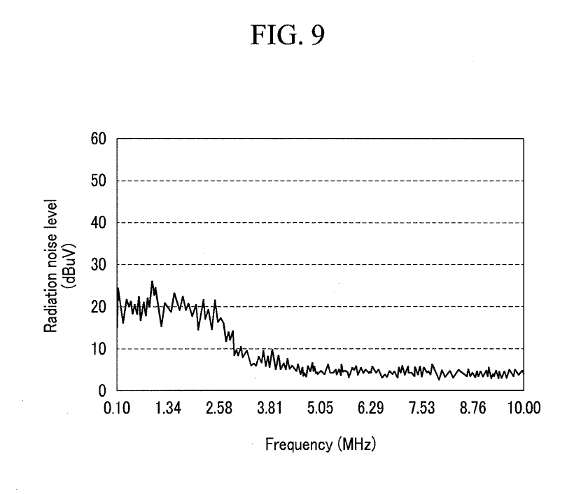

FIG. 8 is a graph showing radiation noise according to conventional art, and FIG. 9 is a graph showing radiation noise according to an exemplary embodiment.

Referring to FIG. 8 and FIG. 9, the radiation noise of the exemplary embodiment is significantly reduced at the same frequency band when compared to the radiation noise of the conventional art. The radiation noise that is reduced in the plasma display device 1 reduces electromagnetic wave interference with peripheral electronic devices.

While this invention has been described in connection with what is considered to be practical exemplary embodiments, it is to be understood that the invention is not limited to the disclosed embodiments, but, on the contrary, is intended to cover various modifications and equivalent arrangements.

What is claimed is:

1. A plasma display device, comprising:
a plasma display panel (PDP), wherein the PDP generates radiated noise when driven with one or more driving signals;
a radiation screen in front of the PDP; and
a noise elimination circuit configured to drive the radiation screen with a noise cancellation signal, wherein the radiation screen generates noise cancellation radiation configured to at least partly cancel the radiated noise from the PDP.

2. The device of claim 1, wherein the radiation screen comprises a filter configured to reduce light reflected from the PDP.

3. The device of claim 1, wherein the radiation screen comprises a filter configured to shield radiation emitted from the PDP.

4. The device of claim 1, wherein the radiation screen comprises a filter electrically floated from the PDP.

5. The device of claim 1, wherein the one or more driving signals is a plurality of driving signals, and the noise elimination circuit generates the noise cancellation signal based on the sum of the driving signals.

6. The device of claim 1, wherein the noise cancellation signal has the opposite polarity of the sum of the driving signals.

7. The device of claim 1, wherein the driving signals are sustain signals.

8. The device of claim 1, further comprising a noise estimator circuit configured to generate a radiation noise signal based on an estimate of noise and to provide the radiation noise signal to the noise elimination circuit.

9. The device of claim 8, wherein the estimate is based on the sum of the driving signals.

10. The device of claim 1, further comprising a noise detector circuit configured to generate a radiation noise signal based on detected noise and to provide the radiation noise signal to the noise elimination circuit.

11. The device of claim 1, wherein the noise elimination circuit comprises:
a level shift circuit configured to level shift a radiation noise signal; and
a buffer circuit configured to generate the radiated noise cancellation signal based on the level shifted noise radiation estimate signal.

12. A method of reducing radiated noise from a plasma display device, the method comprising:
applying driving signals to a plasma display panel (PDP), wherein the PDP radiates noise;
generating a noise cancellation signal; and
applying the noise cancellation signal to the front of the PDP, wherein noise cancellation radiation generated in response to the noise cancellation signal at least partly cancels the radiated noise from the PDP.

13. The method of claim 12, wherein applying driving signals to the PDP comprises applying sustain pulses to the PDP to display one or more images.

14. The method of claim 12, wherein generating the noise cancellation signal comprises applying sustain pulses to a noise estimator circuit.

15. The method of claim 14, wherein the noise estimator circuit is configured to generate a radiation noise signal based on an estimate of the PDP radiated noise, and to provide the radiation noise signal to a noise elimination circuit configured to generate the noise cancellation signal and to apply the noise cancellation signal to a radiation screen on the front of the PDP.

16. The method of claim 15, wherein the estimate is based on the sum of the driving signals.

17. The method of claim 14, wherein the noise estimator circuit is configured to generate a radiation noise signal based on detected PDP radiated noise, and to provide the radiation noise signal to a noise elimination circuit configured to generate the noise cancellation signal and to apply the noise cancellation signal to a radiation screen on the front of the PDP.

18. The method of claim 12, wherein the noise cancellation signal is applied to a radiation screen on the front of the PDP, and the radiation screen comprises a filter configured to reduce light reflection from the PDP.

19. The method of claim 12, wherein the noise cancellation signal is applied to a radiation screen on the front of the PDP, and the radiation screen comprises a filter configured to shield radiation from the PDP.

20. The method of claim 12, wherein the noise cancellation signal is applied to a radiation screen on the front of the PDP, and the radiation screen comprises a filter electrically floated from the PDP.
